(19) United States
(12) Patent Application Publication
(10) Pub. No.: US 2011/0294320 A1
(43) Pub. Date: Dec. 1, 2011

(54) WALL PHONE JACK COVER APPARATUS

(76) Inventor: David Scranton Bennett, Woodstock, GA (US)

(21) Appl. No.: 13/113,160

(22) Filed: May 23, 2011

Related U.S. Application Data
(60) Provisional application No. 61/348,543, filed on May 26, 2010.

(51) Int. Cl. H01R 13/44

(52) U.S. Cl. 439/135

(57) ABSTRACT

An apparatus for covering an unused wall telephone jack assembly is disclosed, the apparatus additionally hosting one or more items such as a notepad, writing instrument, whiteboard, keys or picture frame. The apparatus has a frame that fits over the wall telephone jack assembly and conceals it. The apparatus is attached to the wall jack using either wall telephone jack screws or wall phone mounting screws located on the wall telephone jack assembly. Several embodiments and variations are presented; the one embodiment has a front plate and a back plate comprising the frame; another embodiment having the frame as a single unit. In the embodiments, an elastic ribbon mounted on the front of the frame that releasably supports a notepad, and a shelf mounted on the frame supports a writing instrument are included. The inventive concept applies to other unused wall-mounted electrical devices.

### CROSS-REFERENCE TO RELATED APPLICATIONS

This application claims the benefit of the U.S. Provisional Patent Application No. 61/348,543 filed May 26, 2010 by the present inventor. This provisional patent application is incorporated herein by reference.

### TECHNICAL FIELD

This invention relates cover plates for wall-mounted electrical devices, more particularly to landline phone jack assemblies.

### BACKGROUND OF THE DISCLOSURE

The standard landline telephone is connected to a landline telephone network via a telephone jack. This jack is typically mounted on a baseboard or on a wall. However, in the last several years, mobile devices such as cell phones and smartphone devices have come into increasing use. These mobile devices connect to a mobile telephone network via cell phone towers and Wi-Fi networks. While some users use their cell phones to complement their landline phone, an increasing number of cell phone users use their cell phone as their only telephone, and disconnect their landline service altogether. The landline wall jacks therefore remain unused, and unsightly. Therefore, there is a need for an inexpensive way of converting the unused jack into a useful item.

There are many patent publications, patents, and commercial products that add functionality to either a landline telephone or a wall-mounted electrical connection such as a telephone jack, 120v electrical line, or a light switch plate. However, in all of these devices, the electrical device is kept operational. Therefore, there is a need for an apparatus to convert an unused wall telephone wall jack or other wall-mounted unused electrical device into a useful device.

### SUMMARY OF THE DISCLOSURE

The landline wall phone jack cover apparatus presented herein converts an unused wall phone jack assembly into a device that hosts items such as a notepad, pencil, whiteboard, or a picture frame. The apparatus is mounted over the phone jack, covers it completely, and is attached to the wall plate receptacle using either the same two screws that the wall phone jack assembly uses to attach to the wall, or screws on the wall phone jack assembly used to attach a wall phone to it. In three embodiments presented herein, the apparatus has a frame that is larger than the wall jack and is sized and configured to hold both a notepad of standard size e.g. 5½ inches by 8½ inches. Also included is a writing instrument holder. Optional additional capabilities or variations on the design may also be included such as having a hook to hold keys or replacing the notepad by a white board or having a picture frame; and modifying the apparatus to be used with other wall-mounted unused electrical devices.

### BRIEF DESCRIPTION OF THE DRAWINGS

FIG. 1 illustrates a generic wall telephone jack (not part of the invention) presented herein.

FIG. 2 illustrates a perspective view of the inventive concept presented herein.

FIG. 3 illustrates an exploded perspective view of a first embodiment of the present invention comprising a front plate and a back plate.

FIG. 4 illustrates a sectional view of FIG. 3.

FIG. 5 illustrates a second embodiment, a variation of the first embodiment.

FIG. 6 illustrates an exploded perspective view of a third embodiment of the present invention comprising a single plate.

FIG. 7 illustrates a sectional view of FIG. 6.

### DETAILED DESCRIPTION

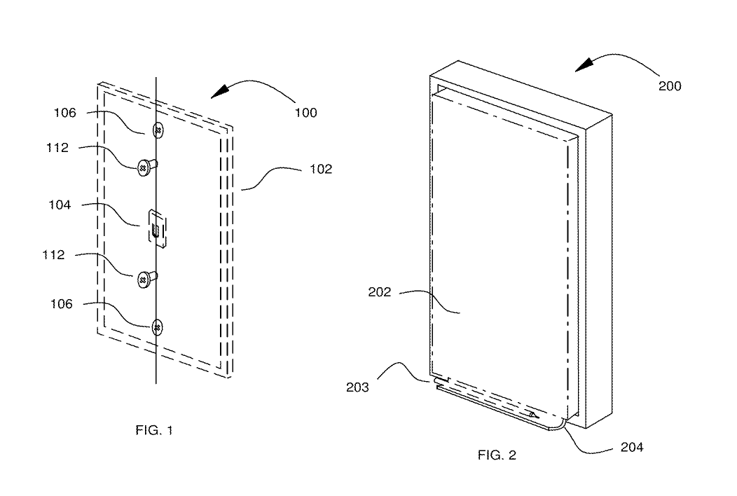

FIG. 1 illustrates a generic example of a wall-mounted telephone jack assembly 100 that accepts a telephone plug. The wall mounted telephone jack assembly 100 is not part of the inventive concept. FIG. 2 illustrates the inventive concept presented herein; a generic example of a telephone jack cover 200 designed to fit over and hide the wall mounted telephone jack assembly 100. Wall-mounted telephone jack assembly 100, installed on a wall, has a telephone jack cover plate 102, a telephone jack 104, typically an RH11 jack, two telephone jack wall-mounting screws 106, and optionally has two telephone-mounting screws 112. Telephone jack cover 200 has a shelf 204 that serves as a writing instrument holder that holds a writing instrument 203 such as a pen or pencil. Telephone jack cover 200 is designed to be attached to and hide the wall-mounted telephone jack assembly 100, and host devices such as a notepad 202 and writing instrument 203.

Wall-mounted telephone jack assembly 100, illustrated in FIG. 1, is one example of a class of telephone jack assemblies. Many variations of such telephone jack assemblies are currently commercially available. Variations include having two telephone jacks 104 instead of one, not having telephone-mounting screws 112, and having the telephone jack wall-mounting screws 106 hidden. The wall phone jack cover invention presented herein covers all these prior art telephone jack assemblies.

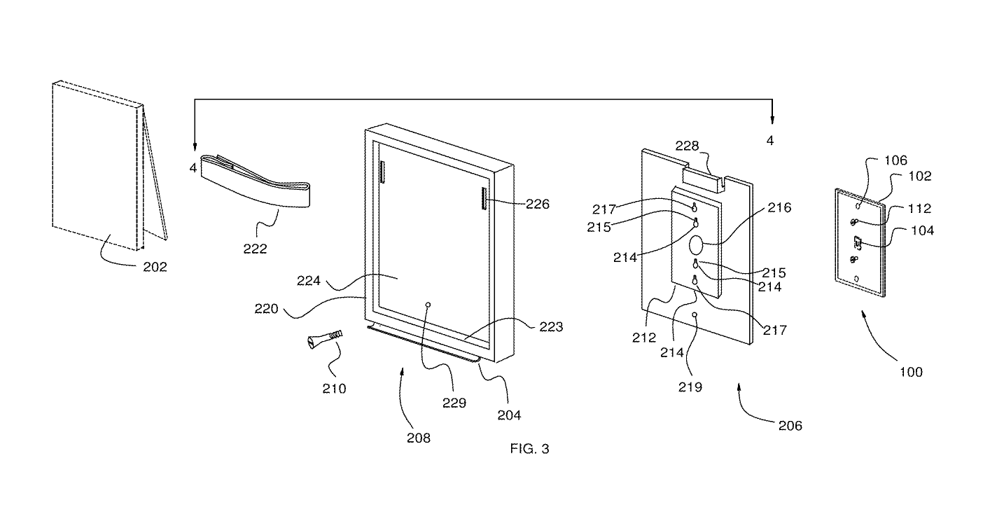

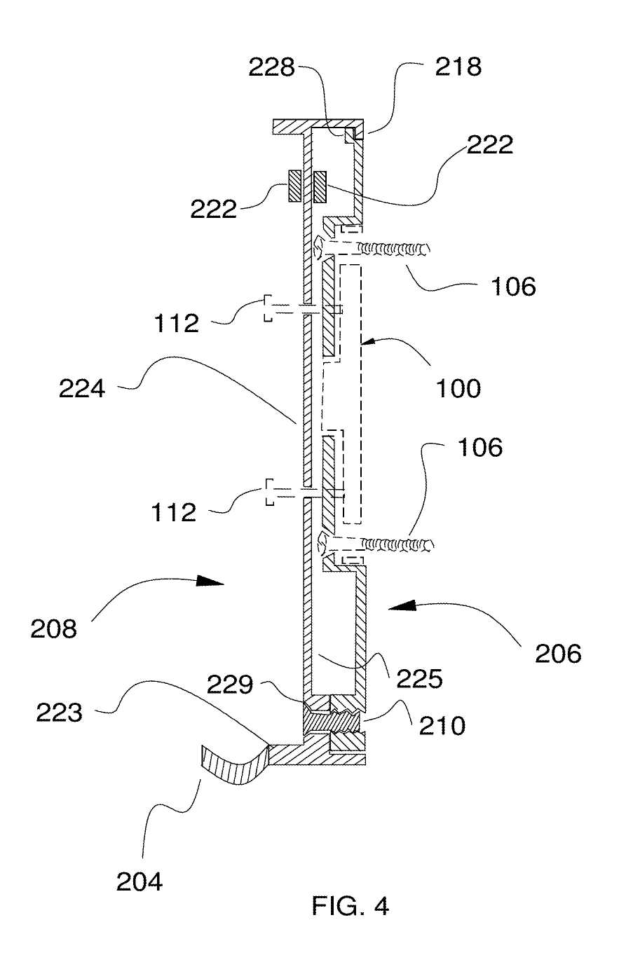

FIG. 3 illustrates an exploded perspective view of a first embodiment of the present invention. FIG. 4 illustrates a sectional view of FIG. 3 displayed in an expanded scale. Referring to FIGS. 3 and 4, first embodiment is comprised of a back plate assembly 206, a front plate assembly 208, an elastic ribbon 222, and a frame screw 210. Back plate assembly 206 has a raised component 212 that contains two slotted holes 314 with slots 215 and a cavity 216. Raised component 212 is sized and configured so it fits over and completely encloses the wall-mounted telephone jack assembly 100. A first pair of slotted holes 214 are sized and configured so back plate assembly 206 may be secured to wall-mounted telephone jack assembly 100 using telephone-mounting screws 112 of wall-mounted telephone jack assembly 100. Cavity 216 is sized and configured so that it allows telephone jack 104 to be enclosed by it. Back plate assembly 206 has a hooked tab 228 that is used to help secure front plate assembly 208 to back plate assembly 206. Back plate assembly 206 also has a threaded hole 219. A second pair of slotted holes 217 are sized and configured so back plate assembly 206 may alternately be secured to wall-mounted telephone jack assembly 100 using the two telephone jack wall-mounting screws 106.

Referring to FIGS. 3 and 4, front plate assembly 208 is comprised of a front plate frame 220, and a frame screw 210. Front plate frame 220 has a frame border 223, and a frame front recess component 224 that is sized and configured to hold a notepad 202. Front plate frame 220 also has a rectangular recess 225, (see FIG. 4), positioned in rear of front plate frame 220 that encloses and conceals the back plate assembly 206.

Again referring to FIGS. 3 and 4, elastic ribbon 222 is secured to front plate frame 220 by passing through two vertical slots 226 located on frame front recess component 224. Front plate frame 220 has a lip 218 (see FIG. 4) located at top of front plate frame 220 that is operationally matched to hooked tab 228 positioned on back plate assembly 206 so it can be hooked over lip 218 to help secure the top of front plate frame 220 to back plate assembly 206. Frame front recess component 224 on front plate frame 220 has a countersunk hole 229 that is positioned to be aligned with threaded hole 219 positioned on back plate assembly 206 and receives frame screw 210. Front plate frame 220 additionally has a shelf 204 attached near bottom of frame border 223. Frame screw 210 fits through countersunk hole 229 and has male threads that mate with female threads in threaded hole 219. Elastic ribbon 222 is mounted on frame front recess component 224 using two vertical slots 226 located near the top and sides of frame front recess component 224. Although not shown in the figures, a key holder such as a hook may also be included.

Again referring to FIGS. 3 and 4, back plate assembly 206 is installed on wall-mounted telephone jack assembly 100 using two telephone-mounting screws 112, using the following steps. The two telephone-mounting screws 112 are loosened, the first pair of slotted holes 214 of back plate assembly 206 are positioned over the two telephone-mounting screws 112 of wall-mounted telephone jack assembly 100 so back plate assembly 206 completely encloses the wall-mounted telephone jack assembly 100. Back plate assembly 206 is then forced down so slots 215 of slotted holes 214 are gripped by the two telephone-mounting screws 112. Telephone-mounting screws 112 are then tightened, thereby securing the back plate assembly 206 to wall-mounted telephone jack assembly 100.

If the two telephone-mounting screws 112 are not present in the wall-mounted telephone jack assembly 100, then the two telephone jack wall-mounting screws 106 of wall-mounted telephone jack assembly 100 may be used to secure the back plate assembly 206 to the wall-mounted telephone jack assembly 100. To install back plate assembly 206 on wall-mounted telephone jack assembly 100 using the two telephone jack wall-mounting screws 106, the following steps are implemented. The two telephone jack wall-mounting screws 106 are loosened, the second par of slotted holes 217 of back plate assembly 206 are fit over telephone jack wall-mounting screws 106 of wall-mounted telephone jack assembly 100 so back plate assembly 206 completely encloses the wall-mounted telephone jack assembly 100. Back plate assembly 206 is then forced down so slots 215 of the second pair of slotted holes 217 are gripped by the two telephone jack wall-mounting screws 106. Telephone jack wall-mounting screws 106 are then tightened, thereby securing the back plate assembly 206 to wall-mounted telephone jack assembly 100.

After back plate assembly 206 is installed on wall-mounted telephone jack assembly 100, front plate assembly 208 is attached to back plate assembly 206 as follows. First, hooked tab 228 on back plate assembly 206 is hooked onto lip 218 of front plate assembly 208, and then front plate frame 220 is positioned over back plate assembly 206 so it completely encloses it. Then frame screw 210 is used to secure front plate assembly 208 to threaded hole 219 on back plate assembly 206. This completes the installation.

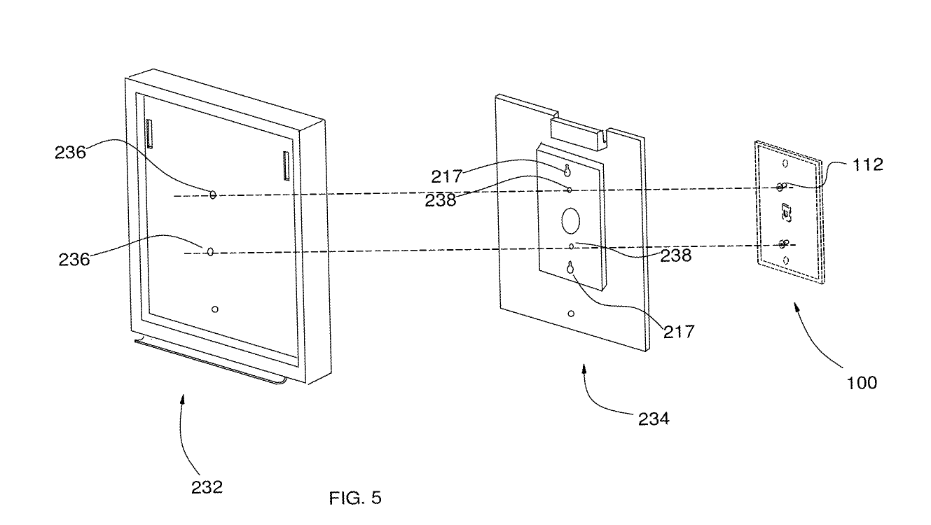

FIG. 5 illustrates a second embodiment, a variation of the first embodiment. Only the differences between the first embodiment and the second embodiment are discussed. The front plate assembly 208 of the first embodiment is replaced by a second front plate assembly 232 of the second embodiment that has two front plate holes 236 added. The back plate assembly 206 of the first embodiment is replaced by a second back plate assembly 234 which has first pair of slotted holes 214 replaced by two back plate holes 238. The two front plate holes 236 are sized and configured so that the heads of the two telephone-mounting screws 112 will fit though the two front plate holes 236. The two back plate holes 238 are sized and configured so that the threads of the two telephone-mounting screws 112 pass through, but the heads of the telephone-mounting screws 112 do not pass through. The two front plate holes 236 and two back plate holes 238 are positioned on the second front plate assembly 232 and the second back plate assembly 234 so that the third embodiment may be secured to the wall-mounted telephone jack assembly 100 using two telephone-mounting screws 112.

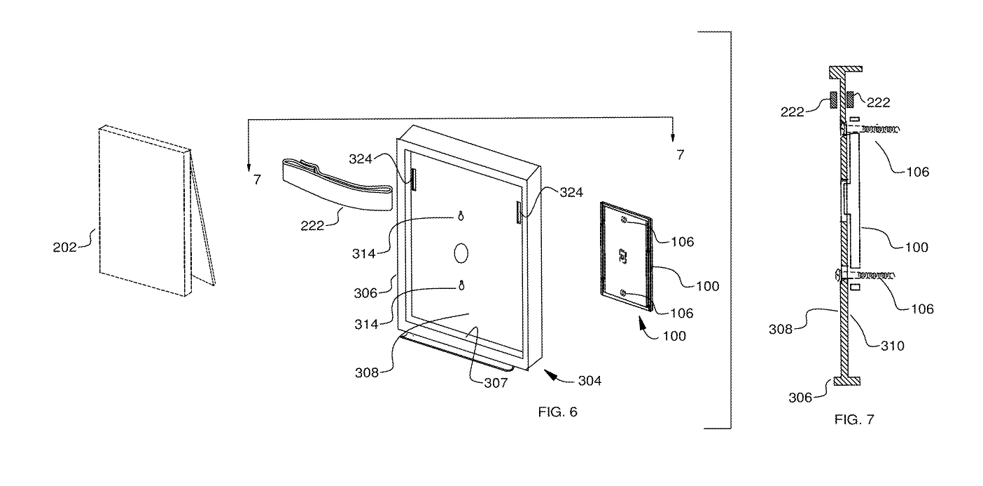

FIG. 6 illustrates an exploded perspective view of a third embodiment of the present invention. FIG. 7 illustrates a sectional view of third embodiment in an expanded scale, the section taken vertically bisecting the third embodiment as indicated in FIG. 6. Third embodiment is designed to handle a wall-mounted telephone jack assembly 100 that does not have wall phone mounting screws. Third embodiment has a frame 306 made using a frame assembly 304 that replaces front plate assembly 208 and back plate assembly 206 of first embodiment. Also shown in FIG. 6 is wall-mounted telephone jack assembly 100 and notepad 202.

Referring to FIGS. 6 and 7, frame assembly 304 has a frame 306 with a frame border 307 and a front rectangular recess 308 that holds a notepad 202. Frame 306 has a rear recess 310, shown in FIG. 7 that encloses the wall-mounted telephone jack assembly 100 when frame assembly 304 is placed over it. Frame assembly 304 has two slotted holes 314 located in front rectangular recess 308. Two slotted holes 314 are positioned so that when frame assembly 304 is placed over wall-mounted telephone jack assembly 100, two slotted holes 314 will align with the telephone jack wall-mounting screws 106 so that telephone jack wall-mounting screws 106 may be used to secure frame assembly 304 to wall-mounted telephone jack assembly 100. Two slotted holes 314 are countersunk on the front so that telephone jack wall-mounting screws 106 will fit flush with front rectangular recess 308. Elastic ribbon 222 is secured to front rectangular recess 308 by passing through ribbon slots 324 located on front rectangular recess 308 and securing the two ends of elastic ribbon 222 on the rear of front rectangular recess 308.

Third embodiment is designed for mounting on wall-mounted telephone jack assembly 100 using telephone jack wall-mounting screws 106. Alternately, third embodiment may be modified to be mounted on wall-mounted telephone jack assembly 100 using two telephone-mounting screws 112 as illustrated in the first embodiment.

The disclosure presented herein gives several embodiments of the present invention. These embodiments are to be considered as only illustrative of the invention and not a limitation of the scope of the present invention. Various permutations, combinations, variations, and extensions of these embodiments are considered to fall within the scope of this invention. For example, one or more hooks may be added to the frame so that keys may be hung from it. The instrument holder may be redesigned; for example, it may be on the side of the frame, and have a hollow tube to insert a pencil or pen. The notepad may be replaced by a whiteboard, blackboard, or other erasable device, and the writing instruments may include one or more wet erase or dry erase markers, chalk or other erasable marking devices. The embodiments may be made out of wood, plastic or metal. Various versions of each embodiment may be made that are dimensioned to fit notepads of different sizes, accommodate phone wall jack assemblies with different number of phone jacks, with or without wall phone mounting screws, visible phone jack mounting screws, and actual construction of the wall phone jack cover. The notepad may be attached to the wall phone jack cover by having a horizontal slot on the recess on wall phone jack cover that allows a notepad backing cardboard to fit through it; alternately a clip may secure the notepad to the wall phone jack cover. The apparatus may be modified to cover an unused electrical wall-mounted device other than a phone jack assembly.

What is claimed is:

1. An apparatus for covering an unused wall-mounted electrical device comprising:
a frame that fits over and is attachable to the unused wall-mounted electrical device such that:
the frame covers and conceals the unused wall-mounted electrical device; and
the frame additionally includes at least one accessory selected from the group consisting of a notepad, a writing instrument, a whiteboard, a blackboard, a key holder, a picture frame, and a combination thereof.

2. An apparatus for covering a wall-mounted telephone jack assembly, the wall-mounted telephone jack assembly having a first pair of screws used for mounting a wall-mounted telephone to the wall-mounted telephone jack assembly and a second pair of screws used for mounting the wall-mounted telephone jack assembly to the wall, the apparatus comprising:
a frame that fits over and is attachable to the telephone wall jack assembly such that the frame conceals the telephone wall jack assembly.

3. The apparatus for covering a wall-mounted telephone jack assembly of claim 2, the apparatus comprising:
the frame having slotted holes positioned and sized so that the first pair of screws may additionally be used for securing the frame to the wall-mounted telephone jack assembly.

4. The apparatus for covering a wall-mounted telephone jack assembly of claim 2, the apparatus comprising:
the frame having slotted holes positioned and sized so that the second pair of screws may additionally be used for securing the frame to the wall-mounted telephone jack assembly.

5. The apparatus for covering a wall-mounted telephone jack assembly of claim 2 further comprising:
a means for releasably attaching a notepad to the frame.

6. The apparatus for covering a wall-mounted telephone jack assembly of claim 5 wherein the means for releasably attaching the notepad to the frame is comprised of an elastic ribbon.

7. The apparatus for covering a wall-mounted telephone jack assembly of claim 2 further comprising:
a means for releasably supporting a writing instrument.

8. The apparatus for covering a wall-mounted telephone jack assembly of claim 7 wherein the means for releasably supporting a writing instrument is comprised of a shelf attached to the frame.

9. The apparatus for covering a wall-mounted telephone jack assembly of claim 2 further comprising:
a means for writing messages, the means for writing messages being mounted on the frame.

10. The apparatus for covering a wall-mounted telephone jack assembly of claim 9 wherein the means for writing messages is selected from the group consisting of a whiteboard, a blackboard, an erasable marker, a piece of chalk, and a combination thereof.

11. The apparatus for covering a wall-mounted telephone jack assembly of claim 2 further comprising:
the frame comprising a front plate and a back plate;
the back plate fitting over the telephone wall jack so that it fully encloses and conceals the telephone wall jack assembly;
the back plate having slotted holes positioned and sized so that the first pair of screws may be used for securing the back plate to the wall;
a means for attaching the front plate to the back plate.

12. The apparatus for covering a wall-mounted telephone jack assembly of claim 11 further comprising:
the means for attaching the front plate to the back plate is comprised of:
a lip positioned on the front plate and a hooked tab positioned on the back plate;
a first hole located on the front plate, a second hole located on the back plate, the second hole being threaded, and a screw wherein the screw mates with the threads of the second hole;
the hooked tab being hooked to the lip, the screw being inserted in the first hole, and the screw being mated to threads to the second hole.
